(19) United States
(12) Patent Application Publication
(10) Pub. No.: US 2011/0196657 A1
(43) Pub. Date: Aug. 11, 2011

(54) Solving a Solute Lubrication Equation for 3D Droplet Evaporation on a Complicated OLED Bank Structure

(76) Inventors: Jie Zhang, Santa Clara, CA (US); Jiun-Der Yu, Sunnyvale, CA (US)

(21) Appl. No.: 12/704,037

(22) Filed: Feb. 11, 2010

(51) Int. Cl. G06F 17/13

(52) U.S. Cl. 703/2; 703/9

(57) ABSTRACT

The present invention is directed to simulating a droplet of a fluid, and may be embodied in a system, method or a computer-readable medium encoded with instructions for a processor to carry out such simulation. The present invention may evaluate differential equations, which may represent an approximation of behavior over time of the droplet on a non-flat substrate. The behavior that the differential equations represent may include diffusion in the droplet and evaporation of the droplet.

### CROSS-REFERENCE TO RELATED APPLICATIONS

The present application is related to following U.S. patent applications: U.S. patent application Ser. No. 12/476,588, filed on Jun. 2, 2009, entitled “A Finite Difference Algorithm for Solving Lubrication Equations with Solute Diffusion” (Attorney Docket No. AP357HO); U.S. patent application Ser. No. 12/411,810, filed on Mar. 26, 2009, entitled “A Finite Element Algorithm for Solving a Fourth Order Nonlinear Lubrication Equation for Droplet Evaporation” (Attorney Docket No. AP363HO); and U.S. patent application Ser. No. 12/579,645, filed Oct. 15, 2009, entitled “An Upwind Algorithm For Solving Lubrication Equations” (Attorney Docket No. AP359HO). Each such related application is incorporated by reference herein in its entirety.

### BACKGROUND

1. Field of Invention

The present application is directed toward systems and methods for simulating the evaporation of a droplet.

2. Description of Related Art

The industrial printing process includes the production of small ink droplets. Each ink droplet may contain a plurality of solvents and solutes. The solute is a metal, polymer, other suitable material, or mixtures of such materials. The solute may be a functional or ornamental material. Each ink droplet may be ejected onto a target area of a patterned substrate. After the droplets lands, the solvent evaporates and a thin film of the solute is formed. Controlling the final pattern of the solute film is essential to assuring the quality and repeatability of the printing process. In order to control the final pattern of the solute film, it is crucial to understand how the final pattern is formed. Understanding the influence of factors such as the evaporation rate, the initial droplet volume, the shape, the initial solute concentration, and the contact line dynamics are crucial in controlling the final pattern. Numerical simulations of the printing process are useful tools for understanding the influence of these factors and for developing the control process for printing.

In the later stage of the ink drying process the aspect ratio of the droplet (the length of the droplet vs. the height of the droplet) increases and becomes quite large. Lubrication theory, which is good for describing the physics of thin films, may be applied to describe the evaporation physics and greatly reduce the complexity of the simulation at the later stage of the ink drying process. Lubrication theory is an approximation of the Navier-Stokes equation for thin films. The application of lubrication theory results in a fourth-order interface evolution equation. The fourth-order interface evolution equation describes the evolution of droplet surface considering the effects of evaporation rate, surface tension, and fluid viscosity. Prior art methods have solved these equations on a flat geometry and assumed that the droplet would take the form of a spherical cap. This assumption is invalid when the surface is not flat.

The present invention involves simulating the solute motion in the presence of evaporation for a droplet sitting on a non-flat surface using lubrication theory in three dimensions.

### SUMMARY OF INVENTION

An embodiment of the present invention may be a system or method for simulating a physical process. The physical process being simulated may be in a droplet. The process being simulated may be the drying of a droplet on a substrate. Simulating the physical process may include using a finite element method to approximate the physical process.

An embodiment of the present invention may be a computer-readable medium encoded with instructions for a processor to perform a method for simulating a droplet of a fluid. The present invention may evaluate a set of differential equations, which may represent an approximation of behavior over time of the droplet on a non-flat substrate. The behavior so represented may include diffusion in the droplet and evaporation of the droplet.

The differential equations may be dependent upon a height function that is representative of the height of the droplet above a plane and/or upon a depth function that is representative of the height of the droplet above the non-flat substrate.

The differential equations may be evaluated based on an initial set of system variables that represent an estimate of the state of the droplet at a first point in time to determine a second set of system variables that represent an estimate of the state of the droplet at a second point in time. The second set of system variables may be stored.

The droplet may include a solute and a solvent. The differential equations may represent diffusion of the solute in the droplet. In an embodiment of the present invention, the finite element method may be used to evaluate the differential equations.

The differential equations may be evaluated in a computational space bounded by a contact line of the droplet. The computational space may be divided into a first region and a gap region. The gap region is a narrow region of computational space between the contact line and the first region. The finite element method is used to evaluate the plurality of differential equations in the first region and extrapolation is used to evaluate the plurality of differential equations in the gap region.

Evaporation in the droplet may be calculated using a first high-order differential function that is representative of the behavior of the height function. The first function is representative of a temporal derivative of the height function (H). The first function is equated to a second function that includes a first term that is a function of the depth function (H-f) of the droplet relative to the substrate (f) and a Laplacian of the height function (∇²H) of the droplet above the plane.

The second function may include a second term that is representative of the evaporation rate of the droplet (J). The diffusion in the droplet is calculated using a second high order differential function that is representative of the behavior of a concentration (C) of solute in the droplet. A temporal derivative of the product of a height of the droplet above the substrate and the concentration ((H-f)C) is equated to a sum of a third function and a fourth function. The third function is a differential function of a product of: the concentration (C), the depth of the droplet (H-f), and a third high order differential function of the height of the droplet (H) above a plane. The fourth function is a differential function of a product of: a differential function of the concentration (C); and the height of the droplet above the substrate (H-f).

An embodiment of the present invention may be a system including a processor for performing the method described above. An embodiment of the present invention may include preparing a fluid in response to the results of a simulation performed using the method described above.

An embodiment of the present invention may include a method of simulating the evolution of a height of an evaporating droplet. The simulation method may include generating a height function that is representative of the height (H) of the droplet above a plane at a first point in time at a plurality of points in a simulation space. The simulation method may also include generating a first differential function that describes a proportional relationship between an intermediate variable and a Laplacian of the height function (∇²H).

The simulation method may also include generating a second differential function. The second differential function may include a first term that is a partial derivative of the height (H) function with respect to time. The second differential function may include a second term that is proportional to the evaporation rate (J) of the droplet. The second differential function may include a third term that is a third function of the height function (H), a height of a non-flat substrate (f) on which the droplet is located, and the intermediate variable.

The simulation method may also include determining the height function at a second point in time by finding an approximate solution using a finite element method that satisfies both the first differential function and the second differential function.

In an embodiment of the present invention the third function is a divergence of a fourth function of the height and the intermediate variable. In an embodiment of the present invention the fourth function is proportional to the cube of the difference between the height function and a height of a non-flat substrate (H-f). In an embodiment of the present invention the fourth function is proportional to the gradient of the intermediate variable.

In an embodiment of the present invention the evaporation rate (J) of the droplet is a function of space and time.

Other objects and attainments together with a fuller understanding of the invention will become apparent and appreciated by referring to the following description and claims taken in conjunction with the accompanying drawings.

### BRIEF DESCRIPTION OF THE DRAWINGS

In the drawings wherein like reference symbols refer to like parts.

FIG. 1 is an illustration of a typical OLED bank structure.

FIG. 2 is an illustration of an OLED bank structure with a non-simple droplet shape sitting on it.

FIG. 3 is an illustration of a portion of a quadrilateral grid and a portion of a gap region.

FIGS. 4A-D are illustrations of experimental data that have been produced according to an embodiment of the present invention.

FIG. 5 is an illustration of a system that includes an embodiment of the present invention that may be used to produce the results shown in FIGS. 4A-D.

### DESCRIPTION OF THE PREFERRED EMBODIMENTS

This present invention is a method based in part on the Finite Element Method (FEM) of simulating a droplet on non-flat substrate. An embodiment of the present invention may be used to simulate a droplet whose dimensions may not be reduced using symmetry.

In the industrial printing process, small ink droplets containing one or more solvents and solutes of desired metal, polymer, or other material(s) are ejected onto the target area of a patterned substrate. After the droplets land onto the targeted area, the solvent evaporates and a thin film of the solute is formed. Being able to control the final pattern of the solute film is important to the application of such industrial printing process. In order to control the final pattern of the solute film, it is crucial to understand how the final pattern is influenced by control factors like evaporation rate, initial droplet volume and shape, initial solute concentration, and contact line dynamics.

Numerical simulations are useful for predicting the behavior a drying droplet and determining qualitative and quantitative relationships between the multitudes of variables that affect the quality of the finished product. An embodiment of the present invention may include adjusting production variables in response to results of one or more simulations that include an embodiment of the present invention.

In the later stage of ink drying, the aspect ratio of length and height becomes quite large. So the lubrication theory, which is good for describing the physics of thin films, could be applied to describe the evaporation physics and greatly reduce the complication of simulation. The application of lubrication theory on the droplet evaporation problem results in two equations: a fourth-order interface evolution equation and a fourth-order solute convection/diffusion equation. The fourth-order interface evolution equation describes the evolution of droplet surface (or interface) considering the effects of evaporation rate, surface tension, and fluid viscosity. The fourth-order solute convection/diffusion equation describes the motion of solute particles under the influences of fluid velocity and particle diffusion. This present invention is regarding how to construct a FEM type algorithm to solve the fourth-order solute equation together with the interface evolution equation with the presence of the OLED bank structure. Prior art methods that have used the FEM have been limited to flat substrates or dimensionally reduced problems.

The present invention is an extension of a previous method described in U.S. patent application Ser. No. 12/476,588, which has been incorporated by reference in its entirety ('588). The present invention describes how to extend the teachings of this related application into three dimensions and how to use the FEM instead of the finite difference method to approximate equations which estimate the behavior of an evaporating droplet.

When a droplet sits on a complex 3-dimensional surface (for example, an OLED bank), the contact line is a complex three dimensional varying curve. This imposes significantly numerical challenges when compared to prior art methods on flat surfaces. The geometry of the contact line causes the curvature terms to be much more complex. These changes would affect the curvature calculation, hence the flow it generates to move the solute. A very accurate calculation needs to be provided in order to obtain a stable numerical solution for solute distribution. In the new solute equation, not only the profile of the droplet, but also the bank structure shape will affect the motion of the solute in a non-linear fashion. In the following paragraphs, we present our invention on a finite element algorithm for the solute lubrication equations to simulate droplet evaporation on a 3D OLED bank structure. Attempts to use prior art FEM implementations have had some difficulty in handling this complex boundary condition.

### Mathematical Modeling and Governing Equations

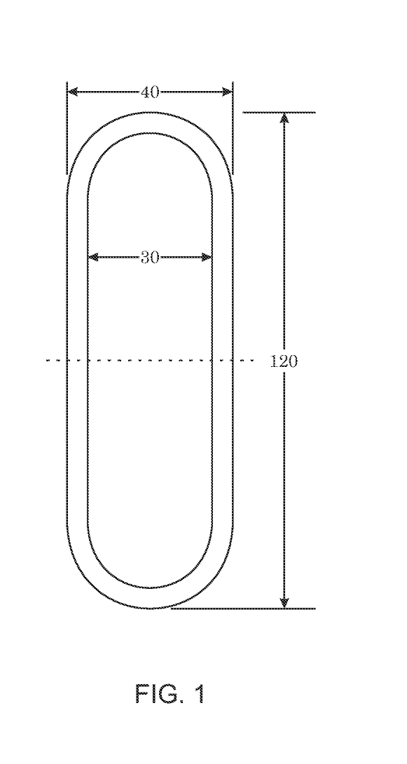

The real OLED bank structure on which a droplet may sit can be quite complicated. The top view for a typical OLED bank structure is illustrated in FIG. 1.

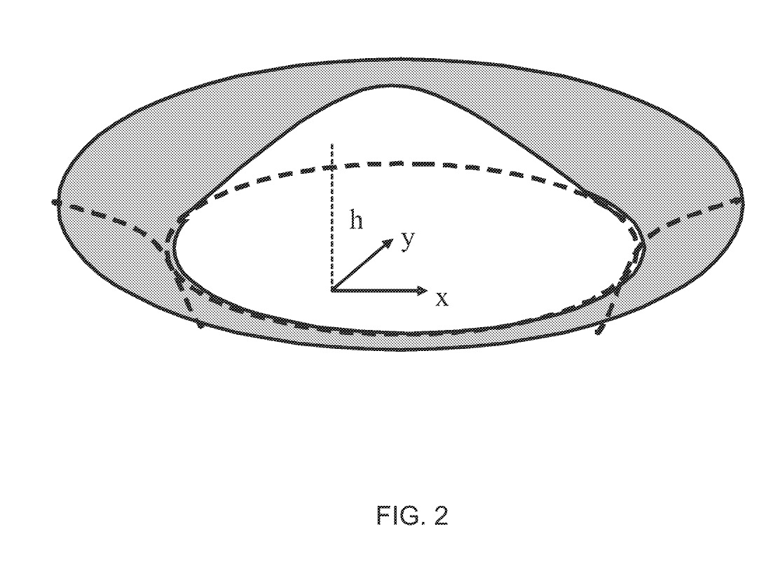

For a non-simple droplet shape, a full three dimension simulation is needed. As shown in FIG. 2, some complex droplets cannot be further simplified to the case where they only depend on one spatial variable.

The inventors have found that equations (1)-(3) give a reasonable approximation of the behavior of an evaporating droplet on a non-flat substrate. A fuller description of the derivation and the units used which are used in equations (1) and (3) may be found in '588, which has been incorporated by reference.

In a Cartesian (x,y,z) coordinate system the governing equations which may be used in an embodiment of the present invention are equations (1)-(2) in which equation (1) is a height evolution equation. The variable H is a spatiotemporal function that describes the height of the droplet relative to a flat plane.

$$\begin{matrix}\frac{\partial H}{\partial t} + \frac{\partial }{\partial x} ( \frac{{( H - f )}^{3}}{3 Ca} \frac{\partial P}{\partial x} ) + \frac{\partial }{\partial y} ( \frac{{( H - f )}^{3}}{3 Ca} \frac{\partial P}{\partial y} ) = - EJ ( x , y , t ) & ( 1 ) \\ P = \frac{{\partial }^{2} H}{\partial {x}^{2}} + \frac{{\partial }^{2} H}{\partial {y}^{2}} & ( 2 )\end{matrix}$$

Here, the variable f is a known spatial function that describes the shape of a non-flat substrate such as the OLED bank structure in FIG. 1. The capillary number Ca is a coefficient which the relative effects of the viscous forces and surface tension in the system being simulated. Equation (2) defines an intermediate variable P that is spatiotemporal function which is useful for reducing the governing equations a fourth order differential function into two coupled second order differential functions.

Equation (3) describes equations (1) and (2) in vector form, which is independent of the coordinate system.

$$\frac{\partial H}{\partial t} + ∇ \cdot ( \frac{1}{3 Ca} {( H - f )}^{3} ∇ {∇}^{2} H ) = - EJ ( x , y , t ) \qquad ( 3 )$$

Equation (4) is a solute advection equation.

$$\frac{\partial ( H - f ) C}{\partial t} + ∇ \cdot ( \frac{1}{3 Ca} {( H - f )}^{3} C ∇ {∇}^{2} H ) = 0 \qquad ( 4 )$$

Note these equations have fourth order spatial derivative, and they are nonlinear. It is a very challenging task to solve these high order nonlinear equations together. The geometrical variation in three dimensions presents significant challenges for the finite difference approach. The inventors have found that a variation on the FEM provides a good accommodation to the present problem.

By introducing the intermediate variable, as in equation (5),

P=∇²H (5)

the height evolution equation (3) may be written as in equation (6)

$$\frac{\partial H}{\partial t} + \frac{1}{3 Ca} ∇ \cdot ( {( H - f )}^{3} ∇ P ) = - EJ ( x , y , t ) , \qquad ( 6 )$$

and the solute evolution equation becomes equation (7)

$$\frac{\partial ( H - f ) C}{\partial t} + ∇ \cdot ( \frac{1}{3 Ca} {( H - f )}^{3} C ∇ P ) = 0. \qquad ( 7 )$$

The weak forms of equations (5)-(7) may be written as equations (8)-(10.

$$\begin{matrix}( P , ϕ ) = - ( ∇ H , ∇ ϕ ) + {\int }_{\partial Ω} ∇ H \cdot \hat{n} d Γ & ( 8 ) \\ ( \frac{\partial H}{\partial t} , ϕ ) = ( \frac{1}{3 Ca} {( H - f )}^{3} ∇ P , ∇ ϕ ) - ( EJ , ϕ ) & ( 9 ) \\ ( \frac{\partial ( H - f ) C}{\partial t} , ϕ ) = ( \frac{1}{3 Ca} {( H - f )}^{3} C ∇ P , ∇ ϕ ) , & ( 10 )\end{matrix}$$

where ∂Ω denotes the boundary of the computational domain Ω, and ∇H·\hat{n} denotes the normal derivative of H on the boundary ∂Ω. The numerical scheme will be discussed in more detail in the following sections.

### Finite Element Numerical Scheme

The solution domain, Ω, is composed of a set of elements. In this case, it is a set of non-overlapping segments which are connected at the edges. Let both H and P have the same element.

Since the droplet is sitting on an OLED bank, the contact line does not necessarily lie in a single plane. The contact line is a three dimensional curve. The contact line is projected onto the x-y plane. A finite element mesh may be generated based upon the shape of the projected contacted line. The finite element mesh may be a quadrilateral mesh. Only some of the elements in the finite element mesh may be quadrilateral elements. The elements closest to the contact line are quadrilateral elements.

When equations (8)-(10) are solved at contact line a singularity is produced. The inventors have found it to be advantageous to solve the weak form of the governing equations (8)-(10) on a shrunken computational domain Ω′. Here, the computational domain Ω is decomposed into two parts Ω′ and Ω_{Gap} as described in equation (11).

Ω=Ω′+Ω_{Gap} (11)

An embodiment of the present invention may be used evaluate a droplet sitting on an OLED bank as discussed below. The droplet may have an initial equilibrium shape at the beginning of a simulation of that includes the effects of evaporation. For sake of simplicity the droplet is assumed to be symmetric along planes x=0, and y=0. The center of the droplet is set as (0,0). It is reasonable to assume the derivate across the symmetry planes is zero as described in equations (12).

$$\frac{\partial H}{\partial x} {\vert}_{x = 0} = 0 \\ \frac{\partial H}{\partial y} {\vert}_{y = 0} = 0 \qquad ( 12 )$$

The boundary conditions at the contact line may be assumed to be given by equations (13)-(15).

H−f|_{∂Ω}=0 (13)

[symbol]

ν [symbol] _{∂Ω}=0 (14)

[symbol]

ν [symbol] C·\hat{n}|_{∂Ω}=0 (15)

While in the following example symmetry has been used to reduce the problem to a quarter of a droplet, an individual skilled in the art will appreciate that a non-reduced problem may be solved with out going beyond the scope and spirit of the present invention. The FEM weak formulation using the decomposed computational space may be written as equations (16)-(18)

$$\begin{matrix}{\int }_{{Ω}^{′}} P ϕ d Ω + {\int }_{{Ω}_{gap}} P ϕ d Ω = {\int }_{\partial Ω} ∇ H \cdot \hat{n} d Γ - {\int }_{{Ω}^{′}} ∇ H \cdot ∇ ϕ d Ω - {\int }_{{Ω}_{gap}} ∇ H \cdot ∇ ϕ d Ω {\int }_{{Ω}^{′}} \frac{\partial H}{\partial t} ϕ d Ω + {\int }_{{Ω}_{gap}} \frac{\partial H}{\partial t} ϕ d Ω - {\int }_{{Ω}^{′}} \frac{{( H - f )}^{3}}{3 Ca} ∇ P \cdot ∇ ϕ d Ω & ( 16 ) \\ - {\int }_{{Ω}_{gap}} \frac{{( H - f )}^{3}}{3 Ca} ∇ P \cdot ∇ ϕ d Ω = - E ( {\int }_{{Ω}^{′}} J ϕ d Ω + {\int }_{{Ω}_{gap}} J ϕ d Ω ) & ( 17 ) \\ {\int }_{{Ω}^{′}} \frac{\partial ( H - f ) C}{\partial t} ϕ d Ω + {\int }_{{Ω}_{gap}} \frac{\partial ( H - f ) C}{\partial t} ϕ d Ω - {\int }_{\partial Ω} \frac{{( H - f )}^{3} C}{3 Ca} ∇ P \cdot ϕ \hat{n} d Γ - {\int }_{{Ω}^{′}} \frac{{( H - f )}^{3} C}{3 Ca} ∇ P \cdot ∇ ϕ d Ω - {\int }_{{Ω}_{gap}} \frac{{( H - f )}^{3} C}{3 Ca} ∇ P \cdot ∇ ϕ d Ω = 0 & ( 18 )\end{matrix}$$

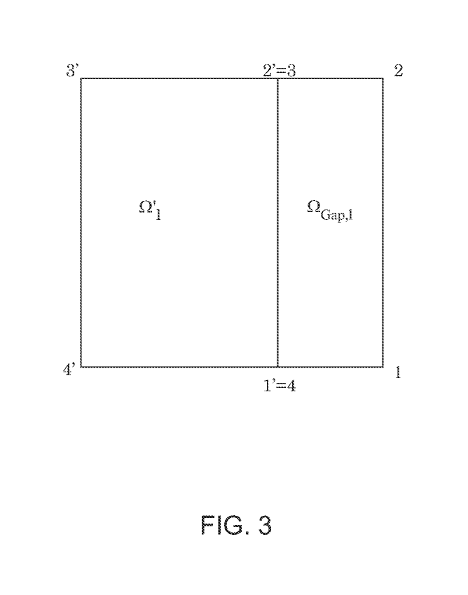

A quadrilateral grid is generated for Ω′. Inside Ω′, a regular testing function is used. For a gap element Ω_{gap,1}, its location relative to its neighbor in Ω′ is illustrated in FIG. 3.

In the Gap region, the intermediate variable P is linear extrapolated as described in equation (19).

P₁=αP₁′+βP₄′

P₂=αP₂′+βP₃′ (19)

In a regular element,

$$\begin{matrix}\begin{matrix}{\int }_{{{Ω}_{l}}^{′}} P ϕ d Ω = {\int }_{{{Ω}_{l}}^{′}} {\sum }_{i} {P}_{i} {N}_{i} ( \vec{x} ) ϕ ( \vec{x} ) d \vec{x} \\ = {\sum }_{k} {ω}_{k} {\sum }_{i} {P}_{i} {N}_{i} ( {\vec{x}}_{k} ) ϕ ( {\vec{x}}_{k} )\end{matrix} & ( 20 ) \\ \begin{matrix}{\int }_{{{Ω}_{l}}^{′}} ∇ H \cdot ∇ ϕ d Ω = {\int }_{{{Ω}_{l}}^{′}} {\sum }_{i} {H}_{i} ∇ {N}_{i} ( \vec{x} ) \cdot ∇ ϕ ( \vec{x} ) d \vec{x} \\ = {\sum }_{k} {ω}_{k} {\sum }_{i} {H}_{i} ∇ {N}_{i} ( {\vec{x}}_{k} ) \cdot ∇ ϕ ( {\vec{x}}_{k} )\end{matrix} & ( 21 )\end{matrix}$$

In matrix form,

AₗPₗ=BₗHₗ (22)

In the gap element,

$$\begin{matrix}\begin{matrix}{\int }_{{Ω}_{Gap}} P ϕ d Ω = {\int }_{{Ω}_{Gap}} {\sum }_{i} {P}_{i} {N}_{i} ( \vec{x} ) ϕ ( \vec{x} ) d \vec{x} \\ = {\sum }_{k} {ω}_{k} {\sum }_{i} {P}_{i} {N}_{i} ( {\vec{x}}_{k} ) ϕ ( {\vec{x}}_{k} )\end{matrix} & ( 23 ) \\ \begin{matrix}{\int }_{{Ω}_{Gap}} ∇ H \cdot ∇ ϕ d Ω = {\int }_{{Ω}_{Gap}} {\sum }_{i} {H}_{i} ∇ {N}_{i} ( \vec{x} ) \cdot ∇ ϕ ( \vec{x} ) d \vec{x} \\ = {\sum }_{k} {ω}_{k} {\sum }_{i} {H}_{i} ∇ {N}_{i} ( {\vec{x}}_{k} ) \cdot ∇ ϕ ( {\vec{x}}_{k} )\end{matrix} & ( 24 ) \\ ( \begin{matrix}{P}_{1} \\ {P}_{2} \\ {P}_{3} \\ {P}_{4}\end{matrix} ) = ( \begin{matrix}α & 0 & 0 & β \\ 0 & α & β & 0 \\ 0 & 1 & 0 & 0 \\ 1 & 0 & 0 & 0\end{matrix} ) ( \begin{matrix}{{P}_{1}}^{′} \\ {{P}_{2}}^{′} \\ {{P}_{3}}^{′} \\ {{P}_{4}}^{′}\end{matrix} ) & ( 25 )\end{matrix}$$

In matrix form,

Pₘ=CₘPₘ′ (26)

For the boundary integral

$$\begin{matrix}{\int }_{\partial {Ω}_{Gap}} ∇ H \cdot \hat{n} ϕ d Γ = {\int }_{\partial {Ω}_{Gap}} {\sum }_{i} {H}_{i} ∇ {N}_{i} ( \vec{x} ) \cdot \hat{n} ( \vec{x} ) ϕ ( \vec{x} ) d \vec{x} \\ = {\sum }_{k} {ω}_{k} {\sum }_{i} {H}_{i} ∇ {N}_{i} ( {\vec{x}}_{k} ) \cdot \hat{n} ϕ ( {\vec{x}}_{k} )\end{matrix} \qquad ( 27 )$$

In combination with all the elements,

APⁿ⁺¹=BHⁿ⁺¹+CH_{B} (28)

This is discrete equation for equation (16). Hence,

Pⁿ⁺¹=A⁻¹BHⁿ⁺¹+A⁻¹CH_{B} (29)

To solve for equation (17), we use semi-implicit time discretization,

$$\begin{matrix}{\int }_{{Ω}^{′}} \frac{{H}^{n + 1} - {H}^{n}}{Δ t} ϕ d Ω + {\int }_{{Ω}_{gap}} \frac{{H}^{n + 1} - {H}^{n}}{Δ t} ϕ d Ω - \frac{1}{3 Ca} {\int }_{{Ω}^{′}} {( {H}^{n} - f )}^{3} ∇ {P}^{n + 1} \cdot ∇ ϕ d Ω - \frac{1}{3 Ca} {\int }_{{Ω}_{gap}} {( {H}^{n} - f )}^{3} ∇ {P}^{n + 1} \cdot ∇ ϕ d Ω = - E ( {\int }_{{Ω}^{′}} {J}^{n} ϕ d Ω + {\int }_{{Ω}_{gap}} {J}^{n} ϕ d Ω ) & ( 30 ) \\ \begin{matrix} {\int }_{{{Ω}_{l}}^{′}} {H}^{n + 1} ϕ d Ω = {\int }_{{{Ω}_{l}}^{′}} {\sum }_{i} {H}_{i}^{n + 1} {N}_{i} ( \vec{x} ) ϕ ( \vec{x} ) d \vec{x} \\ = {\sum }_{k} {ω}_{k} {\sum }_{i} {H}_{i}^{n + 1} {N}_{i} ( {\vec{x}}_{k} ) ϕ ( {\vec{x}}_{k} )\end{matrix} & ( 31 ) \\ \begin{matrix} {\int }_{{{Ω}_{l}}^{′}} {H}^{n} ϕ d Ω = {\int }_{{{Ω}_{l}}^{′}} {\sum }_{i} {H}_{i}^{n} {N}_{i} ( \vec{x} ) ϕ ( \vec{x} ) d x \\ = {\sum }_{k} {ω}_{k} {\sum }_{i} {H}_{i}^{n} {N}_{i} ( {\vec{x}}_{k} ) ϕ ( {\vec{x}}_{k} )\end{matrix} & ( 32 ) \\ \begin{matrix} {\int }_{{{Ω}_{l}}^{′}} {J}^{n} ϕ d Ω = {\int }_{{{Ω}_{l}}^{′}} {\sum }_{i} {J}_{i}^{n} {N}_{i} ( \vec{x} ) ϕ ( \vec{x} ) d x \\ = {\sum }_{k} {ω}_{k} {\sum }_{i} {J}_{i}^{n} {N}_{i} ( {\vec{x}}_{k} ) ϕ ( {\vec{x}}_{k} )\end{matrix} & ( 33 ) \\ \begin{matrix}{\int }_{{{Ω}_{l}}^{′}} {( {H}^{n} - f )}^{3} ∇ {P}^{n + 1} \cdot ∇ ϕ d Ω = {\int }_{{{Ω}_{l}}^{′}} {( {\sum }_{j} {H}_{j}^{n} {N}_{i} ( \vec{x} ) - f )}^{3} \\ {\sum }_{i} {P}_{i}^{n + 1} ∇ {N}_{i} ( \vec{x} ) \cdot ∇ ϕ ( \vec{x} ) d \vec{x} \\ = {\sum }_{k} {{ω}_{k} ( {\sum }_{j} {H}_{j}^{n} {N}_{i} ( {\vec{x}}_{k} ) - f )}^{3} \\ {\sum }_{i} {P}_{i}^{n + 1} ∇ {N}_{i} ( {\vec{x}}_{k} ) \cdot ∇ ϕ ( {\vec{x}}_{k} )\end{matrix} & ( 34 )\end{matrix}$$

For Gap elements,

$$\begin{matrix}\begin{matrix} {\int }_{{Ω}_{Gap}} {H}^{n + 1} ϕ d Ω = {\int }_{{Ω}_{Gap}} {\sum }_{i = 3 , 4} {H}_{i}^{n + 1} {N}_{i} ( \vec{x} ) ϕ ( \vec{x} ) d \vec{x} \\ = {\sum }_{k} {ω}_{k} {\sum }_{i = 3 , 4} {H}_{i}^{n + 1} {N}_{i} ( {\vec{x}}_{k} ) ϕ ( {\vec{x}}_{k} )\end{matrix} & ( 35 ) \\ \begin{matrix} {\int }_{{Ω}_{Gap}} {H}^{n} ϕ d Ω = {\int }_{{Ω}_{Gap}} {\sum }_{i = 3 , 4} {H}_{i}^{n} {N}_{i} ( \vec{x} ) ϕ ( \vec{x} ) d \vec{x} \\ = {\sum }_{k} {ω}_{k} {\sum }_{i = 3 , 4} {H}_{i}^{n} {N}_{i} ( {\vec{x}}_{k} ) ϕ ( {\vec{x}}_{k} )\end{matrix} & ( 36 ) \\ \begin{matrix} {\int }_{{Ω}_{Gap}} {J}^{n} ϕ d Ω = {\int }_{{Ω}_{Gap}} {\sum }_{i = 3 , 4} {J}_{i}^{n} {N}_{i} ( \vec{x} ) ϕ ( \vec{x} ) d \vec{x} \\ = {\sum }_{k} {ω}_{k} {\sum }_{i = 3 , 4} {J}_{i}^{n} {N}_{i} ( {\vec{x}}_{k} ) ϕ ( {\vec{x}}_{k} )\end{matrix} & ( 37 ) \\ \begin{matrix}{\int }_{{Ω}_{Gap}} {( {H}^{n} - f )}^{3} ∇ {P}^{n + 1} \cdot ∇ ϕ d Ω = {\int }_{{Ω}_{Gap}} {( {\sum }_{j = 3 , 4} {H}_{j}^{n} {N}_{j} ( x ) - f )}^{3} \\ {\sum }_{i} {P}_{i}^{n + 1} ∇ {N}_{i} ( \vec{x} ) \cdot ∇ ϕ ( \vec{x} ) d \vec{x} \\ = {\sum }_{k} {{ω}_{k} ( {\sum }_{j = 3 , 4} {H}_{j}^{n} {N}_{j} ( {x}_{k} ) - f )}^{3} \\ {\sum }_{i} {P}_{i}^{n + 1} ∇ {N}_{i} ( {\vec{x}}_{k} ) \cdot ∇ ϕ ( {\vec{x}}_{k} )\end{matrix} & ( 38 )\end{matrix}$$

In matrix form,

DHⁿ⁺¹−EPⁿ⁺¹−E_{Gap}Pⁿ⁺¹=DHⁿ+FJⁿ (39)

From equation (29), we have

[D−(E+E_{Gap})A⁻¹B]Hⁿ⁺¹=DHⁿ+(E+E_{Gap})A⁻¹BH_{B}+FJⁿ (40)

Solving linear system (40) will get the value Hⁿ⁺¹ for next time step n+1. A general linear system solver from the IMSL library may be used to obtain a solution to (40). Note that the bank structure is a known function f. So, exact values for the bank height may be used.

Once Hⁿ⁺¹ is obtained, one can solve the solute equation. Because of the no flux boundary condition, it reduces to equation (41).

$${\int }_{{Ω}^{′}} \frac{\partial ( H - f ) C}{\partial t} ϕ d Ω + {\int }_{{Ω}_{gap}} \frac{\partial ( H - f ) C}{\partial t} ϕ d Ω - {\int }_{{Ω}^{′}} \frac{{( H - f )}^{3} C}{3 Ca} ∇ P \cdot ∇ ϕ d Ω - {\int }_{{Ω}_{gap}} \frac{{( H - f )}^{3} C}{3 Ca} ∇ P \cdot ∇ ϕ d Ω = 0 \qquad ( 41 )$$

To solve (41), we discretize in time and get,

$${\int }_{{Ω}^{′}} \frac{( {H}^{n + 1} - f ) {C}^{n + 1} - ( {H}^{n} - f ) {C}^{n}}{Δ t} ϕ d Ω + {\int }_{{Ω}_{gap}} \frac{( {H}^{n + 1} - f ) {C}^{n + 1} - ( {H}^{n} - f ) {C}^{n}}{Δ t} ϕ d Ω - {\int }_{{Ω}^{′}} \frac{{( {H}^{n + 1} - f )}^{2} ( {H}^{n + 1} - f ) {C}^{n + 1}}{3 Ca} ∇ {P}^{n + 1} \cdot ∇ ϕ d Ω - {\int }_{{Ω}_{gap}} \frac{{( {H}^{n} - f )}^{2} ( {H}^{n + 1} - f ) {C}^{n + 1}}{3 Ca} ∇ {P}^{n + 1} \cdot ∇ ϕ d Ω = 0 \qquad ( 42 )$$

For regular element,

$$\begin{matrix}\begin{matrix}{\int }_{{{Ω}_{l}}^{′}} ( {H}^{n + 1} - f ) {C}^{n + 1} ϕ d Ω = {\int }_{{Ω}_{l}} ( {\sum }_{j} {( {H}^{n + 1} - f )}_{j} {N}_{j} ( \vec{x} ) ) \\ ( {\sum }_{i} {C}_{i}^{n + 1} {N}_{i} ( \vec{x} ) ) ϕ ( \vec{x} ) d \vec{x} \\ = {\sum }_{k} {ω}_{k} ( {\sum }_{j} {( {H}^{n + 1} - f )}_{j} {N}_{j} ( {\vec{x}}_{k} ) ) \\ ( {\sum }_{i} {C}_{i}^{n + 1} {N}_{i} ( {\vec{x}}_{k} ) ) ϕ ( {\vec{x}}_{k} )\end{matrix} & ( 43 ) \\ \begin{matrix}{\int }_{{{Ω}_{l}}^{′}} ( {H}^{n} - f ) {C}^{n} ϕ d Ω = {\int }_{{Ω}_{l}} ( {\sum }_{j} {( {H}^{n} - f )}_{j} {N}_{j} ( \vec{x} ) ) \\ ( {\sum }_{i} {C}_{i}^{n} {N}_{i} ( \vec{x} ) ϕ ( \vec{x} ) ) d x \\ = {\sum }_{k} {ω}_{k} ( {\sum }_{j} {( {H}^{n} - f )}_{j} {N}_{j} ( {\vec{x}}_{k} ) ) \\ ( {\sum }_{i} {C}_{i}^{n} {N}_{i} ( {\vec{x}}_{k} ) ϕ ( {\vec{x}}_{k} ) )\end{matrix} & ( 44 ) \\ {\int }_{{{Ω}_{l}}^{′}} {( {H}^{n} - f )}^{2} ( {H}^{n + 1} - f ) {C}^{n + 1} ∇ {P}^{n + 1} \cdot ∇ ϕ d Ω = {\int }_{{{Ω}_{l}}^{′}} [ \begin{matrix}{( {\sum }_{j} {H}_{j}^{n} {N}_{i} ( \vec{x} ) - f )}^{2} ( {\sum }_{j} {H}_{j}^{n + 1} {N}_{i} ( \vec{x} ) - f ) \\ ( {\sum }_{l} {C}_{l}^{n + 1} {N}_{l} ( \vec{x} ) ) \times {\sum }_{i} {P}_{i}^{n + 1} ∇ {N}_{i} ( \vec{x} ) \cdot ∇ ϕ ( \vec{x} )\end{matrix} ] d x = {\sum }_{k} {ω}_{k} [ \begin{matrix}{( {\sum }_{j} {H}_{j}^{n} {N}_{i} ( {\vec{x}}_{k} ) - f )}^{2} ( {\sum }_{j} {H}_{j}^{n + 1} {N}_{i} ( {\vec{x}}_{k} ) - f ) \\ ( {\sum }_{l} {C}_{l}^{n + 1} {N}_{l} ( {\vec{x}}_{k} ) ) \times {\sum }_{i} {P}_{i}^{n + 1} ∇ {N}_{i} ( {\vec{x}}_{k} ) \cdot ∇ ϕ ( {\vec{x}}_{k} )\end{matrix} ] & ( 45 )\end{matrix}$$

For Gap element,

$$\begin{matrix}\begin{matrix}{\int }_{{Ω}_{Gap}} ( {H}^{n + 1} - f ) {C}^{n + 1} ϕ d Ω = {\int }_{{Ω}_{Gap}} ( {\sum }_{j = 3 , 4} {( {H}^{n + 1} - f )}_{j} {N}_{j} ( \vec{x} ) ) \\ ( {\sum }_{i} {C}_{i}^{n + 1} {N}_{i} ( \vec{x} ) ) ϕ ( \vec{x} ) d \vec{x} \\ = {\sum }_{k} {ω}_{k} ( {\sum }_{j = 3 , 4} {( {H}^{n + 1} - f )}_{j} {N}_{j} ( {\vec{x}}_{k} ) ) \\ ( {\sum }_{i} {C}_{i}^{n + 1} {N}_{i} ( {\vec{x}}_{k} ) ) ϕ ( {\vec{x}}_{k} )\end{matrix} & ( 46 ) \\ \begin{matrix}{\int }_{{Ω}_{Gap}} ( {H}^{n} - f ) {C}^{n} ϕ d Ω = {\int }_{{Ω}_{Gap}} ( {\sum }_{j = 3 , 4} {( {H}^{n} - f )}_{j} {N}_{j} ( \vec{x} ) ) \\ ( {\sum }_{i} {C}_{i}^{n} {N}_{i} ( \vec{x} ) ) ϕ ( \vec{x} ) d \vec{x} \\ = {\sum }_{k} {ω}_{k} ( {\sum }_{j = 3 , 4} {( {H}^{n} - f )}_{j} {N}_{j} ( {\vec{x}}_{k} ) ) \\ ( {\sum }_{i} {C}_{i}^{n} {N}_{i} ( {\vec{x}}_{k} ) ) ϕ ( {\vec{x}}_{k} )\end{matrix} & ( 47 ) \\ {\int }_{{Ω}_{Gap}} {( {H}^{n} - f )}^{2} ( {H}^{n + 1} - f ) {C}^{n + 1} ∇ {P}^{n + 1} \cdot ∇ ϕ d Ω = {\int }_{{Ω}_{Gap}} [ \begin{matrix}{( {\sum }_{j = 3 , 4} {H}_{j}^{n} {N}_{i} ( \vec{x} ) - f )}^{2} ( {\sum }_{j = 3 , 4} {H}_{j}^{n + 1} {N}_{i} ( \vec{x} ) - f ) \\ ( {\sum }_{l} {C}_{l}^{n + 1} {N}_{l} ( \vec{x} ) ) \times {\sum }_{i} {P}_{i}^{n + 1} ∇ {N}_{i} ( \vec{x} ) \cdot ∇ ϕ ( \vec{x} )\end{matrix} ] dx = {\sum }_{k} {ω}_{k} [ \begin{matrix}{( {\sum }_{j = 3 , 4} {H}_{j}^{n} {N}_{i} ( {\vec{x}}_{k} ) - f )}^{2} ( {\sum }_{j = 3 , 4} {H}_{j}^{n + 1} {N}_{i} ( {\vec{x}}_{k} ) - f ) \\ ( {\sum }_{l} {C}_{l}^{n + 1} {N}_{l} ( {\vec{x}}_{k} ) ) \times {\sum }_{i} {P}_{i}^{n + 1} ∇ {N}_{i} ( {\vec{x}}_{k} ) \cdot ∇ ϕ ( {\vec{x}}_{k} )\end{matrix} ] & ( 48 )\end{matrix}$$

In matrix form,

KCⁿ⁺¹−(GPⁿ⁺¹±G_{Gap}Pⁿ⁺¹)Cⁿ⁺¹=KCⁿ (49)

From (29), we have

[K−(G+G_{Gap})(A⁻¹BHⁿ⁺¹+A⁻¹BH_{B})]Cⁿ⁺¹=KCⁿ (50)

Hence, Cⁿ⁺¹ can be obtained. Then, we go back to solve the droplet evolution equation for the next time step.

As a summary, the algorithm involves three steps:

1. From Cⁿ calculate the evaporation rate Jⁿ, where

$$J = {{J}_{o} ( 1 - \frac{{C}^{n}}{{C}_{g}} )}^{α} .$$

2. Solve (41) to get Hⁿ⁺¹,

3. Solve (50) to get Cⁿ⁺¹, then repeat step 1.

### Numerical Results

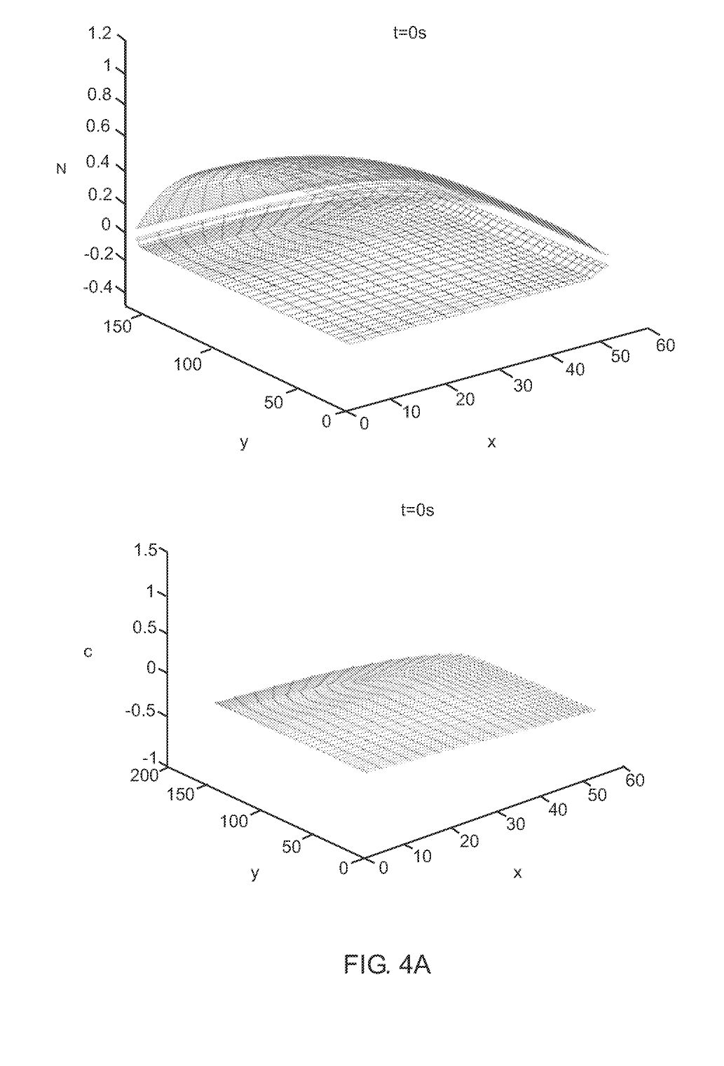

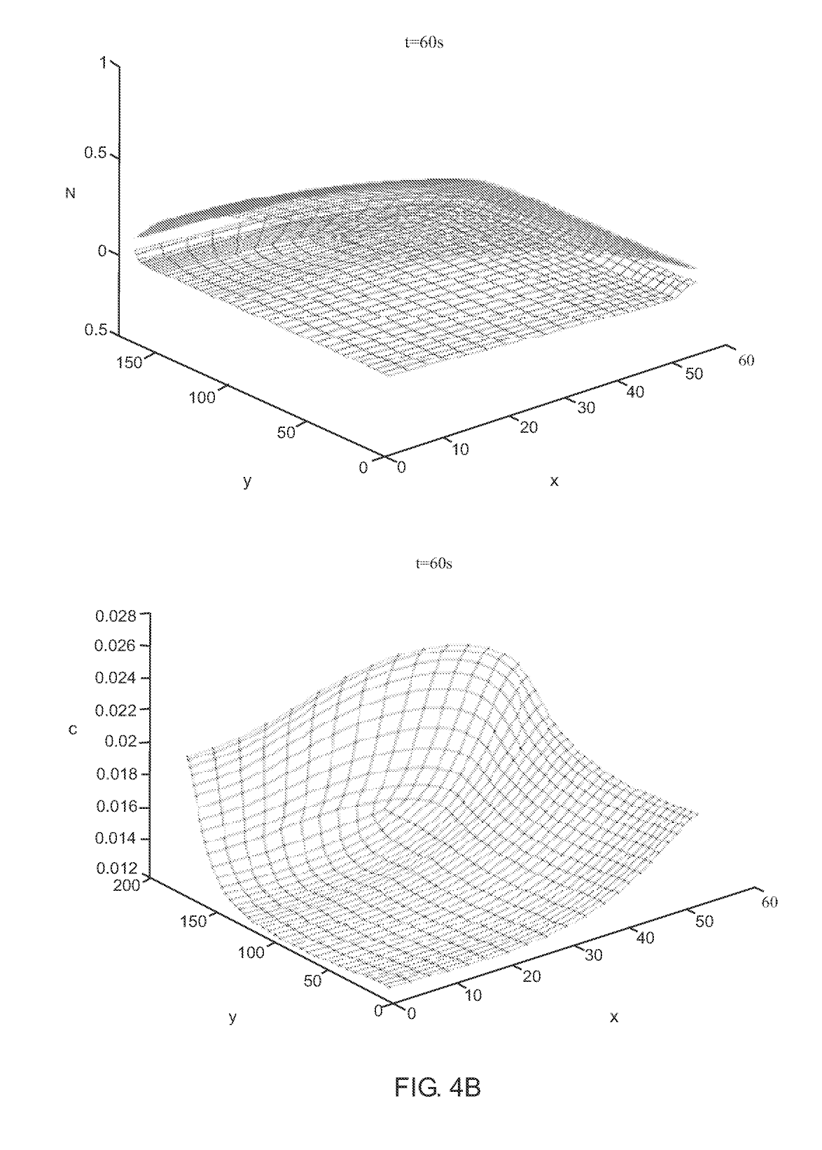

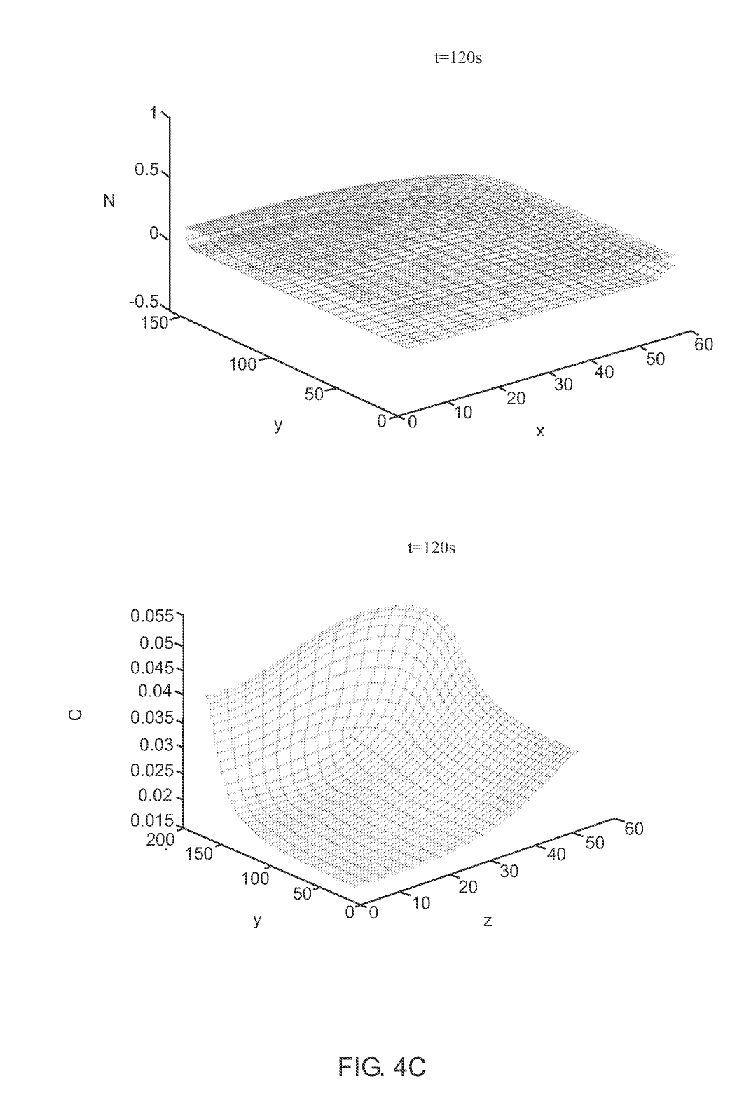

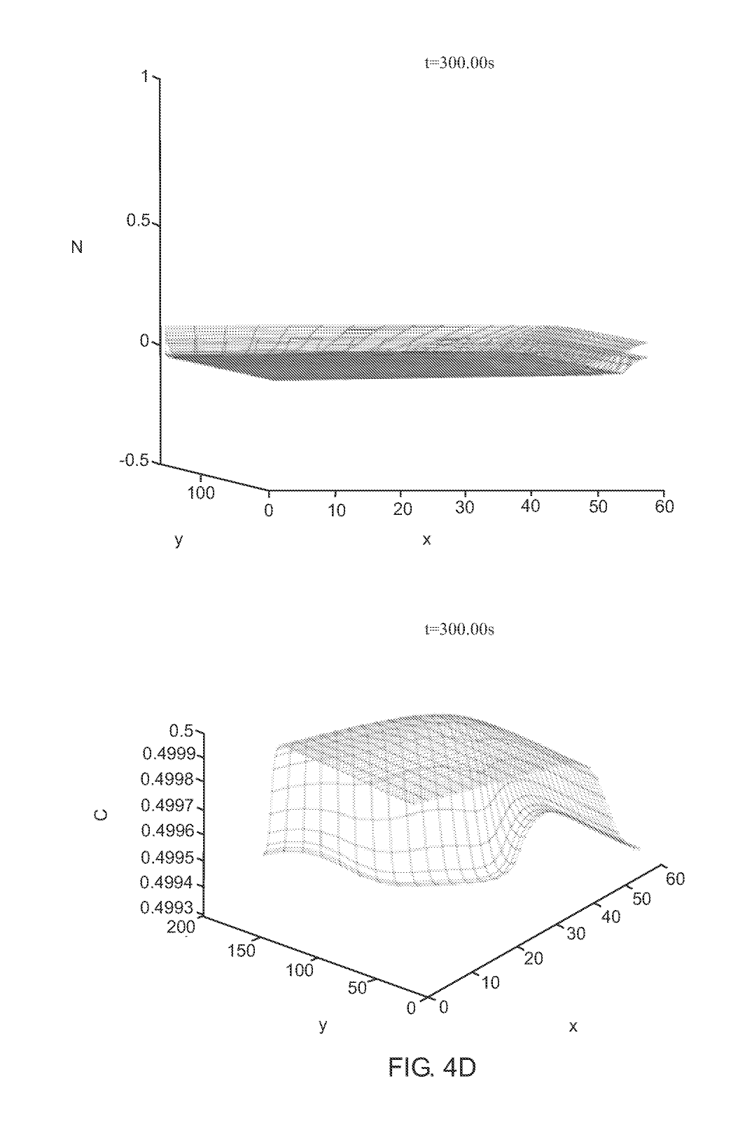

In this section, we illustrate the capability of our finite element scheme described above. FIGS. 4A-D show that the comparison of the solute concentration distributions and droplet interface profiles using different numerical schemes (finite difference and finite element) at different times, t=0, 60, 120, and 300 s, using an experimentally measured viscosity data.

The simulation results in FIGS. 4A-D were made using the following parameters. The droplet is evaporating on an OLED structure. Droplet surface tension is σ=32×10⁻³ N/m, the solvent viscosity is μ₀=3.5×10⁻³ Pa·s, and the Capillary number is Ca=4.627×10⁻⁷. Here, the viscosity varies according to experimentally measured data. The initial droplet volume is 80 μl. The initial contact angle is 40 degrees. The evaporation rate J₀ is 20×10⁻⁸ m/s over the whole simulation period, and dimensionless evaporation parameter E=0.5. The final simulation time is t=300 s.

For the finite element code, we use 740 elements and 792 nodes. Each element has four nodes. In FIGS. 4A-D, the finite element results are shown at different times, t=0, 60, 120, and 300 s. It shows that the solute concentration accumulated near the edge of the OLED structure over time. It eventually reaches the saturated concentration and the evaporation ceased.

The present invention is a variation on the finite element method which is crucial in simulating the final solute deposit pattern and internal flows for a three dimensional slender droplet evaporating on a complicated OLED bank.

### System

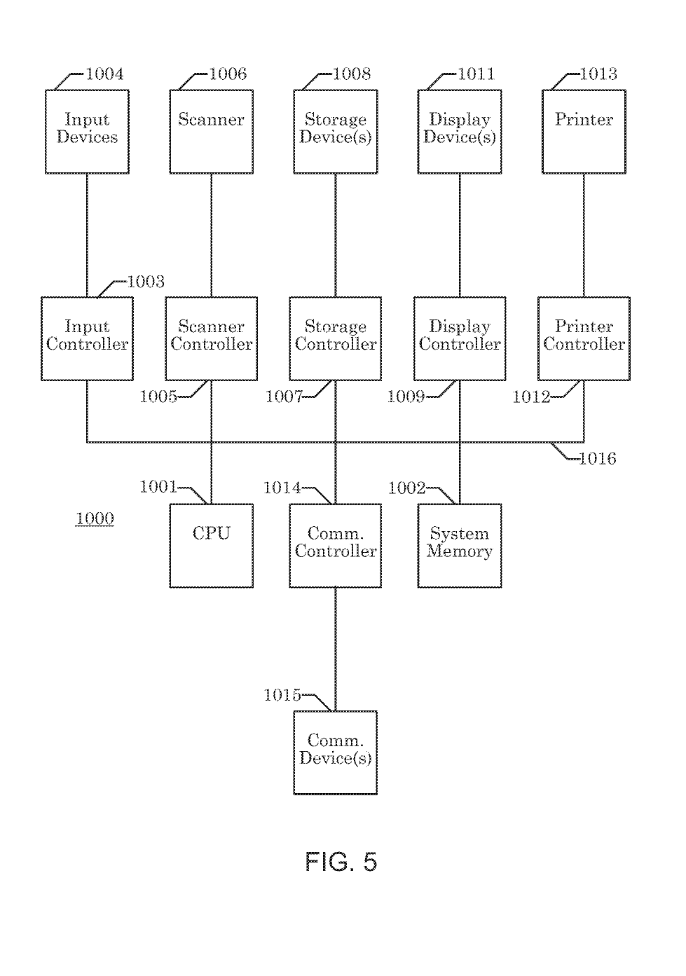

Having described the details of the invention, an exemplary system 1000, which may be used to implement one or more aspects of the present invention, will now be described with reference to FIG. 5. As illustrated in FIG. 5, the system includes a central processing unit (CPU) 1001 that provides computing resources and controls the computer. The CPU 1001 may be implemented with a microprocessor or the like, and may also include a graphics processor and/or a floating point coprocessor for mathematical computations. The system 1000 may also include system memory 1002, which may be in the form of random-access memory (RAM) and read-only memory (ROM).

A number of controllers and peripheral devices may also be provided, as shown in FIG. 5. An input controller 1003 represents an interface to various input device(s) 1004, such as a keyboard, mouse, or stylus. There may also be a scanner controller 1005, which communicates with a scanner 1006. The system 1000 may also include a storage controller 1007 for interfacing with one or more storage devices 1008 each of which includes a storage medium such as magnetic tape or disk, or an optical medium that might be used to record programs of instructions for operating systems, utilities and applications which may include embodiments of programs that implement various aspects of the present invention. Storage device(s) 1008 may also be used to store processed data or data to be processed in accordance with the invention. The system 1000 may also include a display controller 1009 for providing an interface to a display device 1011, which may be a cathode ray tube (CRT), or a thin film transistor (TFT) display. The system 1000 may also include a printer controller 1012 for communicating with a printer 1013. A communications controller 1014 may interface with one or more communication devices 1015 which enables the system 1000 to connect to remote devices through any of a variety of networks including the Internet, a local area network (LAN), a wide area network (WAN), or through any suitable electromagnetic carrier signals including infrared signals.

In the illustrated system, all major system components may connect to a bus 1016, which may represent more than one physical bus. However, various system components may or may not be in physical proximity to one another. For example, input data and/or output data may be remotely transmitted from one physical location to another. In addition, programs that implement various aspects of this invention may be accessed from a remote location (e.g., a server) over a network. Such data and/or programs may be conveyed through any of a variety of machine-readable medium including magnetic tape or disk or optical disc, or a transmitter, receiver pair.

The present invention may be conveniently implemented with software. However, alternative implementations are certainly possible, including a hardware implementation or a software/hardware implementation. Any hardware-implemented functions may be realized using ASIC(s), digital signal processing circuitry, or the like. Accordingly, the term “computer-readable medium” as used herein embraces instructions in the form of either software or hardware, or a combination thereof. With these implementation alternatives in mind, it is to be understood that the figures and accompanying description provide the functional information one skilled in the art would require to write program code (i.e., software) or to fabricate circuits (i.e., hardware) to perform the processing required.

In accordance with further aspects of the invention, any of the above-described methods or steps thereof may be embodied in a program of instructions (e.g., software), which may be stored on, or conveyed to, a computer or other processor-controlled device for execution on a computer-readable medium. Alternatively, any of the methods or steps thereof may be implemented using functionally equivalent hardware (e.g., application specific integrated circuit (ASIC), digital signal processing circuitry, etc.) or a combination of software and hardware.

While the invention has been described in conjunction with several specific embodiments, it is evident that many further alternatives, modifications, and variations will be apparent to those skilled in the art in light of the foregoing description. Thus, the invention described herein is intended to embrace all such alternatives, modifications, and variations as may fall within the spirit and scope of the appended claims.

What is claimed is:

1. A computer-readable medium encoded with instructions for a processor to perform a method for simulating a droplet of a fluid, comprising:
instructions for evaluating a plurality of differential equations, the plurality of differential equations representing an approximation of behavior over time of the droplet on a non-flat substrate, such behavior including diffusion in the droplet and evaporation of the droplet, the plurality of differential equations being dependent upon a height function that is representative of the height of the droplet above a plane and upon a depth function that is representative of the height of the droplet above the non-flat substrate;
instructions for evaluating the plurality of differential equations based on an initial set of system variables that represent an estimate of the state of the droplet at a first point in time to determine a second set of system variables that represent an estimate of the state of the droplet at a second point in time; and
instructions for storing the second set of system variables.

2. The computer-readable medium of claim 1, wherein the droplet includes a solute in a solvent and the plurality of differential equations represent diffusion of the solute in the droplet.

3. The computer-readable medium of claim 1, wherein finite element method is used to evaluate the plurality of differential equations.

4. The computer-readable medium of claim 3, wherein the plurality of differential equations are evaluated in a computational space bounded by a contact line of the droplet, the computational space is divided into a first region and a gap region, the gap region is a narrow region of computational space between the contact line and the first region, the finite element method is used to evaluate the plurality of differential equations in the first region and extrapolation is used to evaluate the plurality of differential equations in the gap region.

5. The computer-readable medium of claim 1, wherein evaporation in the droplet is calculated using a first high order differential function that is representative of the behavior of the height function; wherein a first function is equated to a second function; the first function is representative of a temporal derivative of the height function (H); the second function includes a first term that is a function of the depth function (H-f) of the droplet relative to the substrate (f); and a Laplacian of the height function (∇²H) of the droplet above the plane.

6. The computer-readable medium of claim 5, wherein the second function includes a second term that is representative of the evaporation rate of the droplet (J).

7. The computer-readable medium of claim 1, wherein the diffusion in the droplet is calculated using a second high order differential function that is representative of the behavior of a concentration (C) of solute in the droplet, wherein
a temporal derivative of the product of a height of the droplet above the substrate and the concentration ((H-f)C) is equated to a sum of a third function and a fourth function;
the third function is a differential function of a product of:
the concentration (C);
the depth of the droplet (H-f); and
a third high order differential function of the height of the droplet (II) above a plane; and
the fourth function is a differential function of a product of:
a differential function of the concentration (C); and
the height of the droplet above the substrate (H-f).

8. A system including a processor for performing the method of claim 1.

9. Preparing a fluid in response to the results of a simulation performed using the method of claim 1.

10. A computer-readable medium encoded with instructions for a processor to perform a method for simulating the evolution of a height of an evaporating droplet comprising:
instructions for generating a height function that is representative of the height (H) of the droplet above a plane at a first point in time at a plurality of points in a simulation space;
instructions for generating a first differential function that describes a proportional relationship between an intermediate variable and a Laplacian of the height function (∇²H);
instructions for generating a second differential function comprising:
a first term that is a partial derivative of the height (H) function with respect to time,
a second term that is proportional to the evaporation rate (J) of the droplet, and
a third term that is a third function of the height function (H), a height of a non-flat substrate (f) on which the droplet is located, and the intermediate variable; and
instructions for determining the height function at a second point in time by finding an approximate solution using a finite element method that satisfies both the first differential function and the second differential function.

11. The computer-readable medium of claim 10, wherein the third function is a divergence of a fourth function of the height and the intermediate variable.

12. The computer-readable medium of claim 11, wherein the fourth function is proportional to the cube of the difference between the height function and a height of a non-flat substrate (H-f).

13. The computer-readable medium of claim 11, wherein the fourth function is proportional to the gradient of the intermediate variable.

14. The computer-readable medium of claim 10, wherein the evaporation rate (J) of the droplet is a function of space and time.

15. A system including the processor of claim 10, for performing the instructions recited in claim 10.

16. A method of manufacturing that includes evaporating droplets on a substrate, wherein the manufacturing method is adjusted based on the results of execution of the instructions recited in claim 10.

17. Preparing a fluid in response to the results of the simulation performed execution of the instructions recited in claim 10.

18. The computer-readable medium of claim 10, wherein the height function is determined in the simulation space bounded by a contact line of the droplet, the simulation space is divided into a first region and a gap region, the gap region is a narrow region of simulation space between the contact line and the first region, the finite element method is used to evaluate the height function in the first region and extrapolation is used to evaluate height function in the gap region.
